(19) United States
(12) Patent Application Publication
(10) Pub. No.: US 2026/0091669 A1
(43) Pub. Date: Apr. 2, 2026

(54) Transfer case assembly

(71) Applicant: Countytrac Ltd, Ashford (GB)

(72) Inventors: Eric May, Ashford (GB); John Mather, Ashford (GB)

(73) Assignee: Countytrac Ltd, Ashford (GB)

(21) Appl. No.: 19/348,007

(22) Filed: Oct. 2, 2025

(30) Foreign Application Priority Data
Oct. 2, 2024 (GB) 2414457.8
Sep. 29, 2025 (GB) 2516171.2

(51) Int. Cl. B60K 17/346; B60K 17/22

(52) U.S. Cl. CPC B60K 17/3462; B60K 17/22

(57) ABSTRACT

A transfer case assembly is provided. The transfer case assembly is for transferring torque from a transmission assembly of a motor vehicle to first and second sets of driven wheels of the motor vehicle. The transfer case assembly comprises: a housing, including an integrated transmission and transfer case housing part, the integrated housing part configured to at least partially house a transmission main shaft and a transmission output shaft of the transmission assembly; an input gear for coupling to transmission output shaft; an output flange component for coupling to the output shaft of the transmission assembly, wherein the output flange component is for coupling to the first set of driven wheels of the vehicle; and an output gear drivingly connected to the input gear, wherein the output gear is for coupling to the second set of driven wheels of the vehicle.

### TECHNICAL FIELD

The present disclosure relates to a transfer case assembly for a motor vehicle, and is particularly, although not exclusively, concerned with a transfer case assembly for a motor vehicle with reduced axial length.

### BACKGROUND

All-wheel drive vehicles typically comprise a transfer case assembly coupled to the rear of a transmission assembly for distributing torque from an engine of the vehicle between the front and rear road wheels of the vehicle.

Modern diesel engines are often installed into vehicles together with a number of exhaust gas aftertreatment devices for reducing the amounts of polluting gases emitted in the exhaust gases from the vehicle. As the size and number of exhaust aftertreatment devices increases, e.g. in order to meet increasingly stringent emissions standards, packaging the desirable the exhaust aftertreatment devices within a vehicle fitted with an all-wheel drive system including a transfer case assembly can become challenging.

### STATEMENTS OF INVENTION

According to an aspect of the present disclosure, there is provided a transfer case assembly for transferring torque from a transmission assembly of a motor vehicle to first and second sets of driven wheels of the motor vehicle. The transfer case assembly comprises: a housing, including an integrated transmission and transfer case housing part, the integrated housing part configured to at least partially house a transmission main shaft and a transmission output shaft of the transmission assembly; an input gear for coupling to transmission output shaft; an output flange component for coupling to the output shaft of the transmission assembly, wherein the output flange component is for coupling to the first set of driven wheels of the vehicle; and an output gear drivingly connected to the input gear, wherein the output gear is for coupling to the second set of driven wheels of the vehicle.

The integrated transmission and transfer case housing part may comprise a coupling surface for coupling to an engine, e.g. an engine housing, of a vehicle.

The output flange may be configured to be coupled, e.g. directly coupled, to a first drive shaft for driving the first set of driven wheels, in order to transmit torque directly from the output shaft to the first drive shaft.

The input gear may be arranged for rotation together with the output flange component. The assembly may further comprise a bearing configured to support rotation of the output flange component. The bearing may be mounted, e.g. directly mounted, in the integrated transmission and transfer case housing part. Additionally or alternatively, the bearing may be mounted, e.g. directly mounted, on the transmission output shaft.

The assembly may further comprise a further bearing for supporting, e.g. radially supporting, rotation of the output flange component. The further bearing may be arranged on an opposite side of the input gear, e.g. the meshing portion, from the bearing.

The input gear may further comprise an extension portion protruding axially from a meshing portion of the input gear. The further bearing may be arranged between, e.g. radially between, the extension portion and the housing, e.g. the second part of the housing.

A rotational axis of the output gear may be at an angle relative to a rotational axis of the input gear.

The transfer case assembly may further comprise a conical driven gear drivingly connected to the input gear. The conical driven gear may be meshingly coupled with the output gear.

The transfer case assembly may further comprise a driven shaft bearing for supporting rotation of a driven shaft drivingly coupled to the input gear and the output gear. The driven shaft bearing may be directly mounted in the integrated transmission and transfer case housing part.

The housing may comprise the integrated transmission and transfer case housing part and a second housing part coupled together at a split in the housing. The split may be in a plane perpendicular to the input axis at a position aligned with the input gear. The split may be in a plane perpendicular to the input axis at a position between the bearing and the further bearing. The further bearing may be mounted in a second housing part of the housing.

According to another aspect of the present disclosure, there is provided a transfer case assembly for transferring torque from a transmission assembly of a motor vehicle to first and second sets of driven wheels of the motor vehicle, the transfer case assembly comprising: a housing having a coupling surface for coupling to a housing of the transmission assembly; an input gear for coupling to an output shaft of the transmission assembly; an output flange component for coupling to the output shaft of the transmission assembly, wherein the output flange is for coupling to the first set of driven wheels of the vehicle and an output gear drivingly connected to the input gear, wherein the output gear is for coupling to the second set of driven wheels of the vehicle and wherein the output gear is arranged on an opposite side of the coupling surface, e.g. a plane containing the coupling surface, from the input gear.

The output flange may be configured to be coupled, e.g. directly coupled, to a first drive shaft for driving the first set of driven wheels, in order to transmit torque directly from the output shaft to the first drive shaft.

The input gear may be arranged for rotation together with the output flange component. The assembly may further comprise a bearing configured to support rotation of the output flange component. The input gear and/or the bearing configured to support rotation of the output flange component may be directly mounted on the output flange component.

The housing may be configured to couple to the housing of the transmission assembly, e.g. such that an interior space of the transfer case assembly is in fluidic communication with an interior of the housing of the transmission assembly.

The transfer case assembly may be free from seals, e.g. dynamic seals, for sealing between an opening at the coupling surface between an interior of the transmission assembly casing and an interior of the transfer case assembly housing, and the input gear.

The transfer case assembly may further comprise a gear alignment component configured to couple to the output flange component and axially locate the input gear relative to the output flange component. The gear alignment component may be configured to couple to the output flange component using a threaded coupling. The gear alignment component comprises a seal surface, which may be substantially cylindrical, arranged between the coupling surface and the interior space of the transfer case assembly.

The transfer case assembly may further comprise a seal, e.g. a dynamic seal and/or a static seal, configured prevent or restrict lubricating oil from passing between the coupling surface of the transfer case housing and an interior space of the transfer case housing. The seal may be configured to engage the seal surface of the gear alignment component in order to prevent or restrict lubricating oil from passing between the coupling surface of the transfer case housing and the interior space of the transfer case housing. The input gear may further comprise an extension portion protruding axially from a meshing portion of the input gear towards the coupling surface. The extension portion may at least partially overlap the seal in the axial direction of the shaft. The bearing is arranged between, e.g. radially between, the extension portion and the housing.

The transfer case assembly may comprise a further bearing for supporting rotation of the input gear. The further bearing may be arranged on an opposite side of the input gear, e.g. the meshing portion, from the bearing.

A dimension of the transfer case assembly between the coupling surface and a flange surface of the output flange component may be less than approximately 250 mm or less than approximately 100 mm.

A rotational axis of the output gear may be at an angle relative to a rotational axis of the input gear. The transfer case assembly may further comprise a conical driven gear drivingly connected to the input gear. The conical driven gear may be meshingly coupled with the output gear.

The transfer case housing may comprise first and second housing parts coupled together at a split in the housing. The split may be in a plane perpendicular to the input axis and may be at a position aligned with the input gear. Additionally or alternatively, the split (or another split in the casing) may be at a position between the bearing and the further bearing. Additionally or alternatively, a split in the housing between housing parts, e.g. between the first and second housing parts, may be in a plane perpendicular to the coupling surface and may be aligned with a rotational axis of the output gear.

The transfer case housing may comprise a third housing part coupled to, e.g. between, the first or second housing part. The transfer case housing may comprise a further split in the housing between the first and second housing parts. The split and the further split may be between the first and third, and third and second housing parts respectively. The further split may be in a plane perpendicular to the coupling surface and may be between the rotational axis of the input gear and the rotational axis of the output gear.

According to a second aspect of the present disclosure, there is provided a transfer case assembly for transferring torque from a transmission assembly of a motor vehicle to first and second sets of driven wheels of the motor vehicle, the transfer drive assembly comprising: an output flange component configured to be coupled, e.g. directly coupled, to an output shaft of the transmission assembly and coupled, e.g. directly coupled, to a first drive shaft for driving the first set of driven wheels, in order to transmit torque directly from the output shaft to the first drive shaft; an input gear arranged for rotation together with the output flange component; and a bearing configured to support rotation of the input gear, wherein the input gear and/or bearing is directly mounted on the output flange component.

According to a third aspect of the present disclosure, there is provided a transfer case assembly for transferring torque from a transmission assembly of a motor vehicle to first and second sets of driven wheels of the motor vehicle, wherein the transfer case assembly comprises a housing; and a transfer drive mechanism arranged within an interior space formed by the housing, wherein the transfer case housing is configured to couple to a casing of the transmission assembly such that the interior space of the transfer case assembly is in fluidic communication with an interior of the casing of the transmission assembly.

According to a fourth aspect of the present disclosure, there is provided a transfer case assembly for transferring torque from a transmission assembly of a motor vehicle to first and second sets of driven wheels of the motor vehicle, wherein the transfer case assembly comprises a housing; and a transfer drive mechanism arranged within an interior space formed by the housing, wherein the housing comprises a coupling surface for coupling to a casing of the transmission assembly, such that the interior space of the transfer case assembly is in fluidic communication with an interior of the casing of the transmission assembly.

The transfer case may be free from seals between an opening at the coupling surface between an interior of the transmission assembly casing and the interior space of the transfer case assembly housing, and the drive mechanism within the interior space.

According to a fifth aspect of the present disclosure, there is provided a transfer case assembly for transferring torque from a transmission assembly of a motor vehicle to first and second sets of driven wheels of the motor vehicle, the transfer drive assembly comprising: a housing having a coupling surface for coupling to a housing of the transmission assembly of the motor vehicle; an input gear mounted on a shaft within an interior space of the housing, the shaft for coupling to an output shaft of the transmission assembly; a gear alignment component configured to couple to the shaft and axially locate the input gear relative to the shaft, wherein the gear alignment component comprises a seal surface arranged between the coupling surface and the interior of the transfer case assembly; and a seal configured to engage the seal surface of the gear alignment component in order to prevent or restrict lubricating fluid from passing between the coupling surface of the housing and the interior space.

The shaft may be an output flange component configured to be coupled to an output shaft of the transmission assembly and configured to be coupled to a first drive shaft for driving the first set of driven wheels, in order to transmit torque directly from the output shaft to the first drive shaft.

According to a sixth aspect of the present disclosure, there is provided a transfer case assembly for transferring torque from a transmission assembly of a motor vehicle to first and second sets of driven wheels of the motor vehicle, the transfer drive assembly comprising: a housing having a coupling surface for coupling to a casing of the transmission assembly of the motor vehicle; an input gear mounted on a shaft within an interior space of the housing, the shaft for coupling to an output shaft of the transmission assembly; a bearing configured to support rotation of the shaft; and a seal arranged between the coupling surface and the interior space and configured to prevent or restrict lubricating fluid from passing between the coupling surface of the housing and the interior space, wherein the input gear further comprises an extension portion protruding axially from a meshing portion of the input gear towards the coupling surface, wherein the bearing is arranged between, e.g. radially between, the extension portion and the housing, and wherein the extension portion at least partially overlaps the seal in the axial direction of the shaft.

A motor vehicle may comprise any of the above-mentioned transfer case assemblies. The motor vehicle may further comprise the transmission assembly or the housing of the transmission assembly. The motor vehicle may further comprise a differential assembly having an input gear. A rotational axis of the input gear may be aligned with a rotational axis of the output gear of the transfer case assembly.

To avoid unnecessary duplication of effort and repetition of text in the specification, certain features are described in relation to only one or several aspects or embodiments of the invention. However, it is to be understood that, where it is technically possible, features described in relation to any aspect or embodiment of the invention may also be used with any other aspect or embodiment of the invention. For example, features described in relation to the first mentioned aspect may be combined with the features of the second, third, fourth, fifth and sixth mentioned aspect, and vice versa.

### BRIEF DESCRIPTION OF THE DRAWINGS

For a better understanding of the present invention, and to show more clearly how it may be carried into effect, reference will now be made, by way of example, to the accompanying drawings, in which:

FIG. 1a is a schematic top view of a motor vehicle according to arrangements of the present disclosure;

FIG. 1b is a cross-sectional view of a front differential assembly for the motor vehicle shown in FIG. 1a;

FIG. 2 is a side cross-sectional view of a previously proposed transfer case assembly;

FIG. 3a is a rear perspective view of a transfer case assembly, according to arrangements of the present disclosure, with a housing of the transfer case assembly omitted for clarity;

FIG. 3b is a rear perspective view of a transfer case assembly, according to another arrangement of the present disclosure, with a housing of the transfer case assembly omitted for clarity;

FIG. 4 is a side cross-sectional view of a transfer case assembly, according to arrangements of the present disclosure, taken through an input shaft of the transfer case assembly;

FIG. 5 is a side cross-sectional view of a transfer case assembly, according to arrangements of the present disclosure, taken through a driven shaft and an output shaft of the transfer case assembly;

FIG. 6 is a side cross-sectional view of a transfer case assembly, according to another arrangement of the present disclosure, taken through an input shaft of the transfer case assembly;

FIGS. 7a and 7b are side cross-sectional views of the transfer case assembly, according to arrangements of the present disclosure, taken through a transfer shaft of the transfer case assembly;

FIGS. 8a and 8b are rear perspective and side views of the transfer case assembly, according to arrangements of the present disclosure, respectively; and

FIG. 9 is a rear perspective view of a transfer case assembly, according to another arrangement of the present disclosure.

FIG. 10 is a side view of a transfer case assembly, according to another arrangement of the present disclosure;

FIG. 11 is a side cross-sectional view of a transfer case assembly, according to another arrangement of the present disclosure, taken through an input shaft of the transfer case assembly;

FIG. 12 is a side cross-sectional view of a transfer case assembly, according to another arrangement of the present disclosure, taken through a driven shaft and an output shaft of the transfer case assembly;

FIG. 13 is a side cross-sectional views of a transfer case assembly, according to another arrangement of the present disclosure, taken through a transfer shaft of the transfer case assembly;

FIG. 14 is a rear perspective view of a transfer case assembly, according to another arrangement of the present disclosure, with a housing part of the transfer case assembly omitted for clarity; and

FIG. 15 is a rear perspective view of the transfer case assembly, according to another arrangement of the present disclosure.

### DETAILED DESCRIPTION

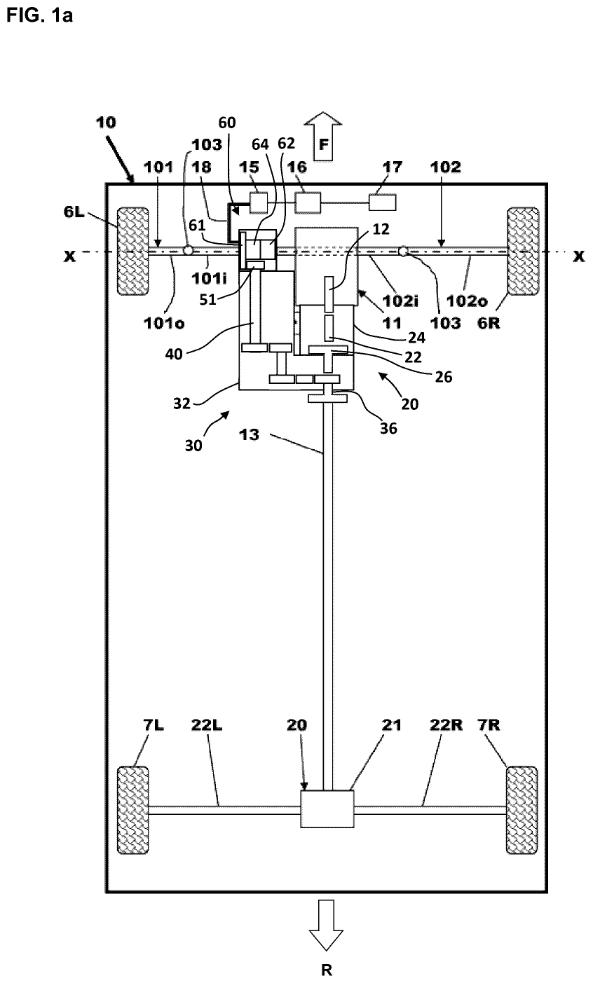

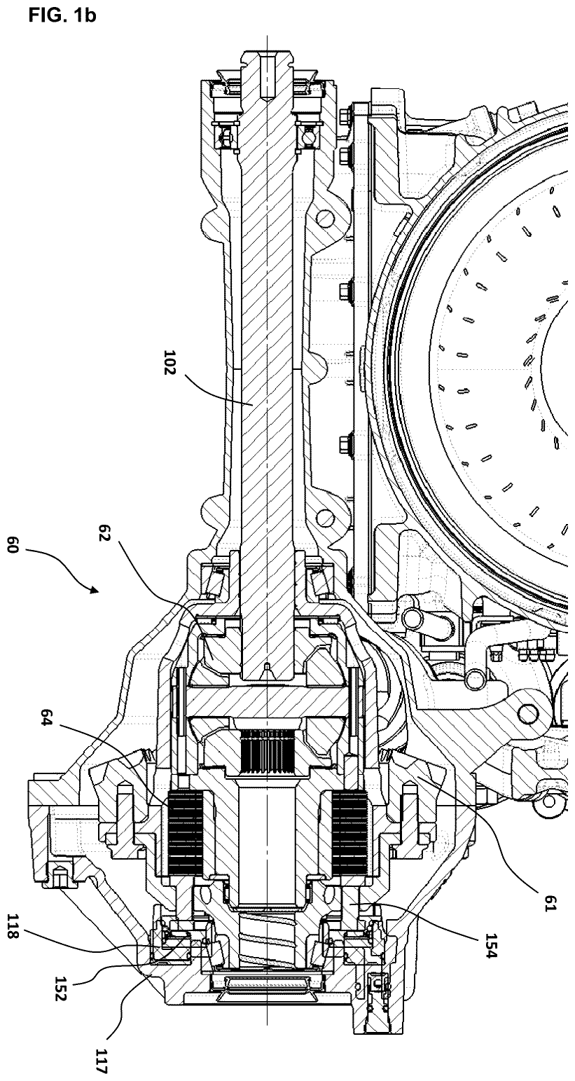

With reference to FIG. 1a, a vehicle 10, such as a motor vehicle, according to arrangements of the present disclosure, may comprise an engine 11, which may be arranged longitudinally in the motor vehicle 10. In FIG. 1a, a forward direction of motion for the motor vehicle 10 is indicated by arrow “F” and a rear direction of motion is indicated by arrow “R”.

The vehicle 10 may comprise a transmission assembly 20. The transmission assembly 20 may be mounted on the rear of the engine 11, e.g. via a bell housing. An input shaft 12 from a clutch (not shown) may be interposed between the engine 11 and the transmission assembly 20 and may drive a transmission main shaft 22 within a housing 24 of the transmission assembly 20. The transmission assembly 20 further comprises an output shaft 26, which may protrude rearwardly beyond the housing 24 of the transmission assembly.

The vehicle 10 may further comprise a transfer case assembly 30. The transfer case assembly may be mounted to the rear of the transmission assembly. The transfer case assembly may comprise a transfer housing 32 for housing components of the transfer case assembly 30, such as a drive mechanism for transferring drive from the transmission assembly 20 to first and second sets of road wheels, e.g. front and rear road wheels, of the vehicle, as described in greater detail below. The transfer housing 32 may be coupled to the housing 24 of the transmission assembly and an output flange component 36 of the transfer case assembly may be coupled to the output shaft 26 of the transmission assembly.

The transfer case assembly 30 may be arranged with its primary drive connected, e.g. drivingly connected, to the first set of road wheels, e.g. rear road wheels 7L, 7R, of the motor vehicle. In particular, the output flange component 36 may be coupled to a first, rear, drive shaft 13, such as a conventional prop shaft, extending from the transfer case assembly 30 to a rear differential unit 21 arranged for driving rear wheel drive shafts 22L, 22R.

Drive for the second set of road wheels, e.g. front road wheels 6L, 6R of the motor vehicle may be taken off the output shaft 26 via the transfer case assembly 30. In particular, the transfer case assembly may comprise a transfer drive shaft 40 drivingly connected to the output shaft 26 of the transmission assembly via the drive mechanism of the transfer case assembly 30.

The transfer drive shaft 40 of the transfer case assembly 30 may be coupled, e.g. drivingly coupled, to a front differential assembly 60 for driving the front road wheel via front wheel drive shafts. In particular, a pinion gear 51 provided on the transfer drive shaft 40 may be meshingly engaged with a ring gear 61, e.g. a hypoid ring gear, of the front differential assembly 60. The pinion gear 51 may be referred to as an input gear of the front differential assembly 60.

According to arrangements of the present disclosure, and with further reference to FIG. 1b, the front differential assembly 60 may be a combined coupling and differential assembly 60. The combined coupling and differential assembly 60 may comprise a differential 62, and an engageable coupling 64 configured to selectively couple the ring gear 61 to the differential 62. The combined coupling and differential assembly 60 is configured to selectively provide drive torque to the front wheels 6L, 6R via respective first and second front wheel drive shafts 101,102 (drive shaft 101 not illustrated in FIG. 1b). When the engageable coupling 64 of the combined coupling and differential assembly 60 is engaged, drive torque supplied to the ring gear 61 may be transferred to the differential 62 in order to supply drive torque to the first and second front wheel drive shafts 101, 102. In this way, the transfer case assembly 30 and front differential assembly 60 may be configured to drive the front road wheels 6L, 6R of the vehicle 10.

In the arrangement depicted, the engageable coupling 64 is a conventional plate clutch, such as a multi-plate clutch. In such arrangements, the coupling mechanism 64 comprises alternate outer and inner clutch plates respectively connected with a clutch drum and a clutch hub. When the engageable coupling is engaged, the alternating plates of the clutch are forced to engage one another and transmit drive torque between the outer and inner clutch plates via friction, to thereby transfer toque between the coupling drum and the coupling hub. In other arrangements, the engageable coupling 64 may be any other type of coupling suitable for selectively transmitting drive torque from the ring gear 61 to the differential 62.

The first, left hand front wheel drive shaft 101 may comprise inner and outer parts 101i, 101o, which may be respectively joined together by a constant velocity or universal joint 103. The second, right hand front wheel drive shaft 102 may similarly comprise inner and outer parts 102i, 102o, with may be respectively joined together by a constant velocity or universal joint 103.

The vehicle 10 may further comprise an actuation system for the engageable coupling 64 of the combined coupling and differential assembly 60. The actuation system may be an electro-hydraulic actuation system and may comprise a source of hydraulic power 15 controlled by an electronic controller 16.

As illustrated in FIG. 1b, the electro-hydraulic actuation mechanism may comprise an actuator piston 152. The actuator piston 152 may be an annular actuator piston. As depicted, the actuator piston may be slidingly located within a recess 118, e.g. an annular recess, formed in a housing 117 of the front differential assembly. The electro-hydraulic actuation mechanism may further comprise a thrust transfer element 154, such as a thrust ring, for transferring force from the actuator piston 152 to the engageable coupling 64.

A human machine interface 17 may also be provided to allow an operator of the motor vehicle 10 operate the electro-hydraulic actuation system, e.g. to select or deselect drive to the front wheels 6L, 6R. The source of hydraulic power 15 may be connected to the actuator piston 152 of the combined coupling and differential assembly 60 by a pipe or conduit 18. In one or more arrangements, the source of hydraulic power 15 may comprise a pump and/or a reservoir, and optionally one or more electro-hydraulic valves controlled by the electronic controller 16.

When the vehicle 10 is driving normally along a road, the primary drive is through the differential 21 and rear axle 20. In this configuration, the engageable coupling 64 of the combined coupling and differential assembly 60 may be in a disengaged state. The front wheels 6L, 6R may therefore rotate freely, because there is no drive through the combined coupling and differential assembly 60 to the front wheels 6L, 6R.

If in a particular situation, the rear wheels 7L, 7R begin to slip, then the engageable coupling 64 of the combined coupling and differential assembly 60 can be engaged either automatically by the electronic controller 16 or by a user of the vehicle 10 using the human machine interface 17, e.g. depending upon the configuration and construction of the vehicle 10. When the engageable coupling 64 of the combined coupling and differential assembly 60 is engaged, drive is transmitted to the front wheels 6L, 6R from the engine 11 via the transmission assembly 12, transfer case assembly 30, differential 62 and first and second front wheel drive shafts 101,102, so as to supplement the drive from the rear wheels 7L, 7R.

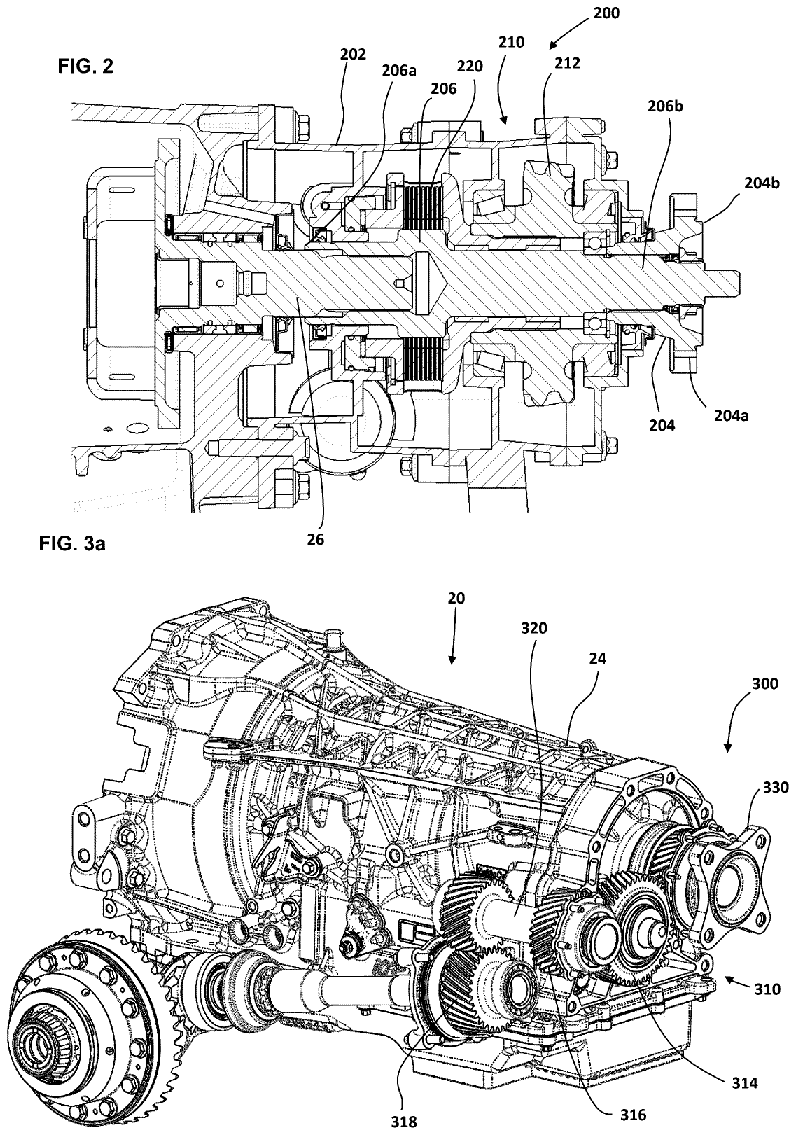

With reference to FIG. 2, a previously proposed transfer case assembly 200 may be provided in place of the transfer case assembly 30, e.g. as part of a previously proposed vehicle. The transfer case assembly 200 comprises a transfer housing 202 and an output flange component 204. As described above, the output flange component 204 is drivingly connected to the output shaft 26 of the transmission assembly 20 and is configured to couple to the rear drive shaft 13 for driving the rear road wheels of the motor vehicle. The output flange component 204 comprises a flange portion 204a comprising a flange face 204b configured to engage the rear drive shaft 13.

The transfer case assembly 200 comprises an input shaft 206 coupled to the output shaft 26 of the transmission assembly at a first end 206a and to the output flange component 204 at a second end 206b.

The transfer case assembly 200 further comprises a drive transfer mechanism 210 for transferring drive from the input shaft 206 to an output shaft (not shown) of the transfer case assembly 200 for driving the front road wheels of the vehicle, e.g. via a front differential assembly, as described above. The drive transfer mechanism 210 may comprise a chain drive including an input sprocket 212 couplable to the input shaft and connected to an output sprocket (not shown) coupled to the output shaft of the transfer case assembly 200 via a chain. Alternatively, the drive transfer system may comprise a gear drive configured to transfer drive from the input shaft to the output shaft via two or more of meshing gears.

In the arrangement shown, the transfer case assembly 200 further comprises a clutch 220, such as a plated friction clutch, for selectively coupling the input sprocket 212 to the input shaft 206, e.g. such that the input sprocket 212 is driven to rotate together with the input shaft 206.

As indicated in FIG. 2, an axial length of the transfer case assembly 200, e.g. in a direction parallel with an axis of rotation of the output flange component 204, which may be a longitudinal direction of the motor vehicle, between a coupling surface 202a of the housing 202, at which the housing is coupled to the housing of the transmission assembly 20, to the flange face 204b of the output flange component, e.g. at which the transfer case assembly coupled to the rear drive shaft for driving the rear road wheels of the vehicle may be typically greater than 250 mm. In comparison, the axial space typically provided between a transmission assembly, e.g. a housing the transmission assembly, and rear drive shaft in a rear wheel drive vehicle, e.g. which is not configured to allow drive to be supplied to front wheels of the vehicle, may be typically less than 100 mm.

In some vehicles, e.g. comprising particular configurations of exhaust gas aftertreatment devices, an axial space available for the transfer case assembly to be provided between the transmission assembly 20 and the rear drive shaft 13 may be reduced compared to previously proposed vehicles. In particular, an axial space available for the transfer case assembly may be less than the typically required greater than 250 mm. For example, an available axial space may be less than 200 mm, approximately 117 mm or less than approximately 117 mm. Hence, when a vehicle comprises the particular configuration of exhaust gas aftertreatment devices, it may not be possible to configure the vehicle as an all-wheel drive vehicle, e.g. by providing the previously proposed transfer case assembly 200, in order to supply drive to the front road wheels of the vehicle. Instead, previously proposed vehicles comprising the particular configuration of exhaust gas aftertreatment devices may be restricted to being rear wheel drive vehicles only.

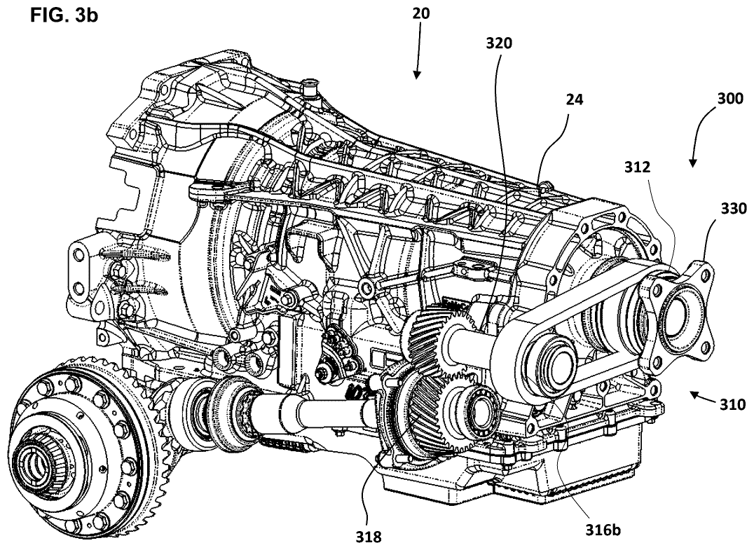

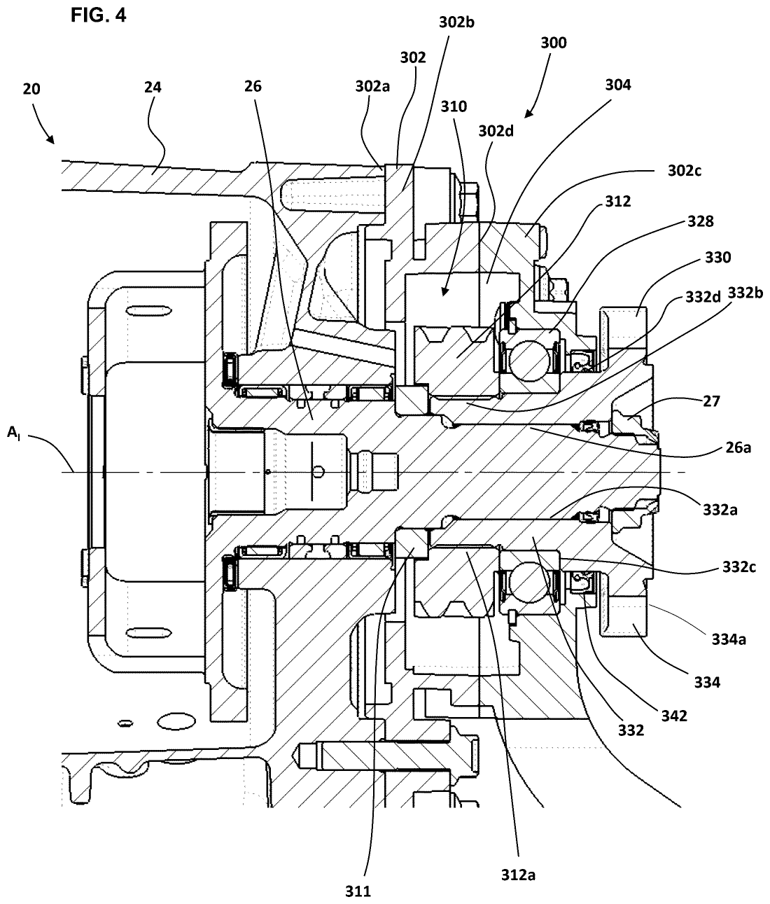

With reference to FIGS. 3a, 4 and 5, a transfer case assembly 300, according to arrangements of the present disclosure, will now be described. The transfer case assembly 300 may be provided within the vehicle 10, according to the present disclosure, e.g. in place of the transfer case assembly 30. The transfer case assembly 300 comprises a housing 302, depicted in FIG. 4, which forms an interior space 304 of the transfer case assembly 300, e.g. for containing a drive mechanism 310 of the transfer case assembly. A coupling surface 302a of the housing is configured to couple to the housing of the transmission assembly 20.

The output shaft 26 of the transmission assembly may protrude from the transmission housing into the interior space 304 through an opening at the coupling surface 302a. The coupling surface 302a may extend around the opening through which the output shaft 26 extends. In some arrangements, such as that depicted in FIG. 4, the output shaft 26 may extend completely through the housing 302 of the transfer case assembly, e.g. up to or beyond an opposite side of the transfer case from the coupling surface 302a.

The transfer case assembly 300 comprises an output flange component 330 for coupling the output shaft 26 of the transmission assembly to the rear drive wheels of the vehicle. The output flange component 330 comprises a shaft portion 332 and a flange portion 334 coupled to or integrally formed with the shaft portion 332. The flange portion is configured for coupling to the rear drive shaft 13 of the vehicle, e.g. at a flange face 334a of the flange portion. The flange portion 334 may comprise one or more fastener bores for fasteners, e.g. threaded fasteners, to pass through the flange portion for coupling the rear drive shaft to the output flange component 330.

The shaft portion 332 may be configured to couple to the output shaft 26 of the transmission assembly for rotation together with the output shaft. As illustrated in FIG. 4, the output flange component, e.g. the shaft portion 332, may be directly coupled to the output shaft 26 of the transmission assembly 20. The output flange component, e.g. the shaft portion 332, may be coupled to the output shaft of the transmission assembly via a splined or keyed connection. For example, the output flange component, e.g. the shaft portion 332, may be tubular and the output shaft 26 may be received inside the hollow interior of the output flange component to be coupled to the output flange component. The output flange component 330 may comprise an internal spline 332a formed inside the hollow interior and the output shaft may comprise an external spline 26a configured to couple to the spline formed on the output flange component.

As illustrated in FIG. 4, the output flange component 330 may be coupled to the output shaft 26 using a fastener 27 threaded onto a distal end of the output shaft. A shoulder of the faster 27 may engage a radially extending surface of the output flange component to axially retain the output flange component 330 on the output shaft 26.

The drive mechanism 310 of the transfer case assembly 300 comprises a gear drive. The drive mechanism comprises an input gear 312 coupled to the output shaft 26 of the transmission assembly, e.g. for rotation together with the output shaft. In alternative arranged, such as the arrangement depicted in FIG. 3b, the drive mechanism 310 may alternatively comprise a chain or belt drive including an input sprocket 312b couplable to the input shaft and connected to an output sprocket 316b coupled to the output shaft of the transfer case assembly 200 via a chain.

As depicted in FIG. 4, the input gear 312 may be mounted, e.g. directly mounted, on the output flange component 330. In particular, the input gear 312 may be coupled to the shaft portion 332 of the output flange component. The output flange component 330, e.g. the shaft portion, may comprise an external spline 332b formed on an outer surface and the input gear 312 may comprise an internal spine 312a for coupling to the external spline formed on the output flange component in order to couple the input gear 312 to the output flange component.

The transfer case assembly 300 may further comprise a bearing 328 for supporting, e.g. radially and/or axially supporting, rotation of the output flange component 330. For example, the bearing 328 may be to react radial and/or axial loads on the output flange component 330 from the rear drive shaft 13 and or the input gear 312. The bearing 328 may be arranged between, e.g. axially between, the input gear 312 and the flange portion 324 of the output flange component. As depicted, the bearing 328 may be a ball bearing.

As illustrated, the output flange component, e.g. the shaft portion, may comprise a shoulder 332c, which may abut the bearing 328 in order to axially locate the output flange component relative to the bearing. The transfer case assembly 300 may further comprise a spacer 311, e.g. an axial spacer, configured to abut a shoulder formed on the output shaft 26 of the transmission. The input gear may be configured to abut the spacer, e.g. in order to axially locate the input gear relative to the output shaft. The bearing 328 may then abut the input gear, such that the bearing and/or the output flange component via the bearing are axially located relative to the output shaft 26.

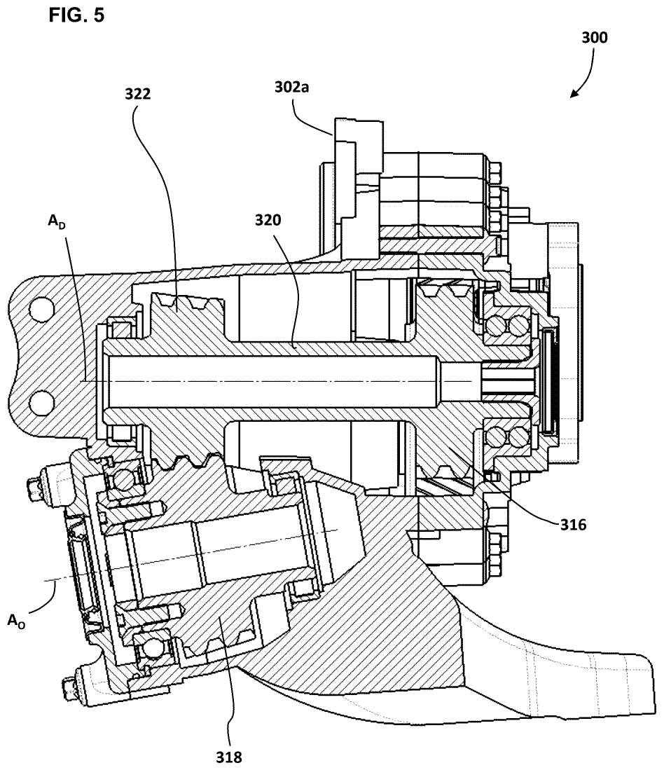

Referring in particular to FIGS. 3a and 5, the drive mechanism 310 of the transfer case assembly may comprise a driven gear 316 coupled to the input gear 312. In particular, the drive mechanism may comprise an idler gear 314 coupled, e.g. meshingly coupled, to the input gear 312 and coupled, e.g. meshingly coupled, to the driven gear 316. The input gear and driven gear may be at least partially aligned with one another in the axial direction of the transfer case assembly.

The driven gear 316 is drivingly connected to an output gear 318 of the transfer case assembly. As shown in FIGS. 3a and 5, the drive mechanism 310 may comprise a driven shaft 320 and the driven gear 316 may be mounted on, or integrally formed with, the driven shaft. An axis of rotation A_{D} of the driven shaft may be parallel with an axis of rotation A_{I} of the input gear (depicted in FIG. 4) which may be referred to as an axial direction of the transfer case assembly. A conical driven gear 322 may also be mounted on, or integrally formed with, the driven shaft 320. The conical driven gear 322 may be coupled, e.g. meshingly coupled, to the output gear 318. The output gear 318 may be a conical gear. An axis of rotation A_{O} of the output gear may therefore be at an angle relative to the axis of rotation A_{D} of the driven shaft 320. In particular, the axis of rotation of the output gear may be aligned with an axis of rotation of the pinion gear 51 coupled, e.g. meshingly coupled, with the ring gear 61 of the front differential assembly 60, described above.

As illustrated in FIGS. 3a and 5, the driven shaft 320 may extend forwards from the driven gear 316, e.g. towards the transmission assembly, in the axial direction of the transfer case assembly, to the conical driven gear 322. The output gear 318 may be at least partially aligned with the conical driven gear in the axial direction of the transfer case assembly. The configuration of the drive mechanism 310 may enable the output gear 318 to be positioned on an opposite side of the coupling surface, e.g. a plane containing the coupling surface, from the input gear. The output gear 318 may be arranged to the side, e.g. lateral side, of the transmission assembly, e.g. the housing 24 of the transmission assembly. This configuration may enable an axial length of the transfer case assembly to be reduced and/or improve relative packaging of the transfer case assembly 300 and the front differential assembly 60.

Returning to FIG. 4, the transfer case assembly 300 may further comprise a rear seal 342 for improving sealing of the interior space 304 at the rear end of the housing 302 (opposite the coupling surface and transmission assembly), e.g. in order to prevent, restrict or reduce the leakage of lubricating fluid from the interior space 304 at the rear end of the housing 302. The rear seal 342 may be arranged between, e.g. axially between, the bearing 328 and the rear end of the housing. As depicted, the rear seal 342 may be arranged between, e.g. radially between, the housing 302 and a sealing surface 332d formed on the output flange component, e.g. the shaft portion. As illustrated, the sealing surface may be a substantially cylindrical outer surface of the output flange component, e.g. the shaft portion. Accordingly, the rear seal 342 may be a dynamic seal configured to seal between the rotating output flange component and the static housing of the transfer case assembly.

However, the transfer case assembly 300 may be free from seals provided between the coupling surface 302a and the drive mechanism 310, e.g. the bearing 328 and/or the input gear 312. Such a seal may be for preventing, restricting or reducing a flow of lubricating fluid from the coupling surface to the drive mechanism, e.g. the bearing 328 and/or the input gear 312, or into the interior space 304. Accordingly, the interior space 304 of the transfer case assembly, e.g. in which the drive mechanism is arranged, may be in fluidic communication with an interior of the transmission assembly in which lubricating fluid, e.g. oil, of the transmission assembly is provided. The interior space 304 of the transfer case assembly may be in fluidic communication with an interior of the transmission assembly via one or more openings into the interior space at the coupling surface. In this way, the transfer case assembly may be configured such that lubricating fluid can flow between the interior of the transmission assembly and the interior space of the transfer case assembly.

As depicted in FIG. 4 an axial length of the transfer case assembly 300, e.g. in an axial direction of the transfer case assembly, which may be based on the axis of rotation of output flange component, may be approximately 92 mm. Accordingly, by providing transfer case assembly as part of the vehicle 10, sufficient space may be provided for packaging a desired configuration of exhaust gas aftertreatment devices in the vehicle together with an all-wheel drive system.

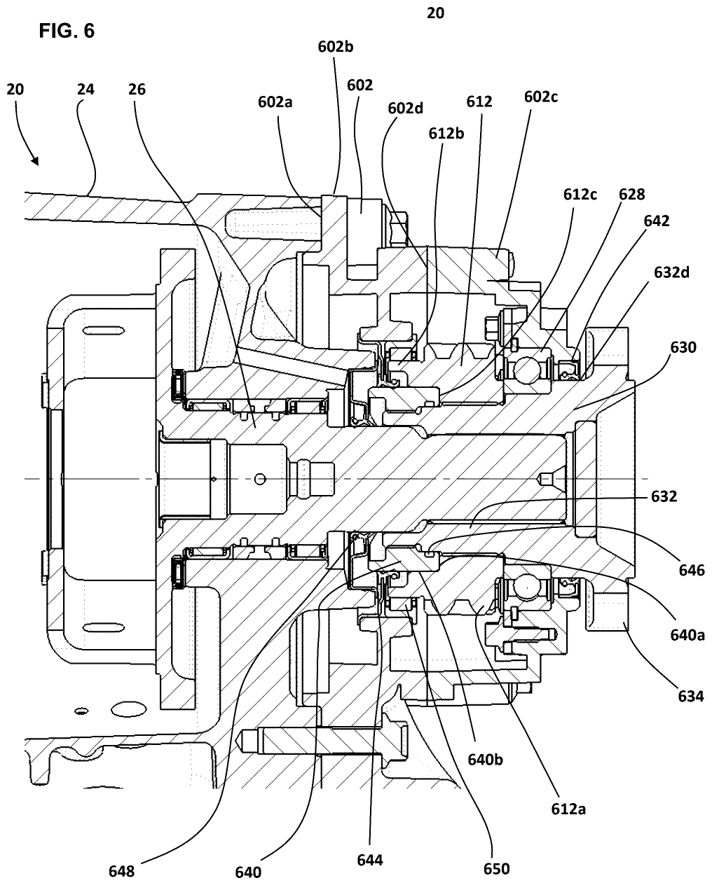

With reference now to FIG. 6, a transfer case assembly 600, according to another arrangement of the present disclosure, will now be described. The transfer case assembly 600 may be provided in the vehicle 10, in place of the transfer case assembly 30 rather than the transfer case assembly 300. The transfer case assembly 600 may be similar to the transfer case assembly 300 and features described in relation to the transfer case assembly 300 may apply equally to the transfer case assembly 600 and vice versa. In particular, the transfer case assembly 600 comprises a housing 602 including a coupling surface 602a for coupling to the transmission assembly housing 24, an output flange component 630 comprising a shaft portion 632 and a flange portion 634 and a drive mechanism 610 including an input gear 612 and an output gear. The drive mechanism 610 may further comprise an idler gear, a driven gear and a driven conical gear mounted on, or integrally formed with, a driven shaft.

The transfer case assembly 600 may differ from the transmission case assembly 300 in that the transfer case assembly 600 may be configured to seal an interior space 604 of the housing, e.g. in which the drive mechanism 610 is arranged, from the interior of the transmission assembly. The transfer case assembly 600 may be configured to seal the interior space 604 of the housing 602, in order to prevent, restrict or reduce leakage of lubricating fluids, e.g. oil, between the interior space 604 and the interior of the transmission assembly 20.

The transfer case assembly 600 may comprise a rear bearing 628 for supporting, e.g. radially supporting, rotation of the output flange component 630. For example, the rear bearing 628 may be to react radial and/or axial loads on the output flange component 630 from the rear drive shaft 13 and or the input gear 612. The bearing may be arranged between, e.g. axially between the input gear 612 and the flange portion 634 of the output flange component. As depicted, the bearing 628 may be a ball bearing.

As illustrated in FIG. 6, the input gear 612 of the transmission assembly 600 may comprise a meshing portion 612a, e.g. on which a plurality of gear teeth are provided, for meshing with other gears of the drive mechanism 610, such as the idler gear. The input gear 612 may further comprise an extension portion 612b extending axially from the meshing portion. The extension portion 612b may comprise a substantially cylindrical portion having an outer surface with a substantially constant radius, e.g. relative to the axis of rotation of the input gear, on which no gear teeth are provided. As illustrated, the extension portion may extend from the meshing portion towards the coupling surface 602a, such that the extension portion is arranged between the meshing portion and the coupling surface.

The transfer case assembly 600 may further comprise a front bearing 650 for supporting, e.g. radially supporting, rotation of the output flange component 630. For example, the front bearing 650 may be to react radial loads on the output flange component 630 from the rear drive shaft 13 and or the input gear 612. The front bearing 650 may be arranged between, e.g. axially between, the input gear 612, e.g. the meshing portion of the input gear, and the coupling surface 602a of the housing. As depicted, the front bearing may be a roller bearing.

In the arrangement shown in FIG. 5, the front bearing 650 is aligned, e.g. axially aligned, with the extension portion 612b of the input gear and is coupled to the input gear 612 at the extension portion for supporting rotation of the output flange component. The front bearing 650 may be positioned between, e.g. radially between, the extension portion of the input gear and the housing 602.

By providing both the rear bearing 628 and the front bearing 650 as described above, the transfer case assembly 600 may be configured to isolate loads on the output flange component 630, e.g. from the input gear and/or rear drive shaft, from the output shaft 26 of the transmission assembly.

The transfer case assembly 600 may further comprise a gear alignment component 640 configured to axially locate the input gear 612 on a shaft that the input gear is mounted on, e.g. on the output flange component 630, and/or within the interior space 604. The gear alignment component 640 may be configured to couple to the shaft that the input gear is mounted on, e.g. to the output flange component, such as the shaft portion 632 of the output flange component. In one or more arrangements, the gear alignment component 640 may be coupled to the shaft using a threaded connected. For example, an internal thread may be formed in a bore of the gear alignment component, which may be configured to be threaded onto an external thread formed on the shaft.

As illustrated, the input gear 614 may comprise a shoulder 612c having a radially extending step formed in the inside surface of the input gear. The shoulder 612c may be aligned with the meshing portion 612a of the input gear, e.g. in the axial direction. An axial end face 640a of the gear alignment component may be configured to engage the shoulder 612c in order to axially locate the input gear.

The transfer case assembly 600 may further comprise a rear seal 642 for improving sealing of the interior space 604 at the rear end of the housing 602 (opposite the coupling surface and transmission assembly), e.g. in order to prevent, restrict or reduce the leakage of lubricating fluid, e.g. oil, from the interior space 604 at the rear end of the housing 602. The rear seal 642 may be arranged between, e.g. axially between, the bearing 628 and the rear end of the housing, opposite the coupling surface. As depicted, the rear seal 642 may be arranged between, e.g. radially between, the housing 602 and a sealing surface 632d formed on the output flange component. Accordingly, the rear seal 642 may be a dynamic seal configured to seal between the rotating output flange component and the static housing of the transfer case assembly.

The transfer case assembly 600 may comprise a front seal 644 arranged to prevent, restrict or reduce leakage of lubricating fluids between the interior space 604 and the interior of the transmission assembly 20. The front seal 644 may be arranged between, e.g. axially between, the coupling surface 602a of the housing, and the input gear 612 and/or front bearing 650.

The gear alignment component 640 may comprise a sealing surface 640b. The sealing surface may comprise a substantially cylindrical outer surface of the gear alignment component. The front seal 644 may be configured to seal against the sealing surface 640b of the gear alignment component in order to prevent, restrict or reduce leakage of lubricating fluids between the interior space 604 and the interior of the transmission assembly 20, e.g. between the gear alignment component and the housing 602. The front seal 644 may be arranged between, e.g. radially between the sealing surface of the gear alignment component and the housing 602. Accordingly, the front seal 644 may be a dynamic front seal.

As illustrated in FIG. 6, the extension portion 612b of the input gear may at least partially overlap the sealing surface 640b of the gear alignment component in the axial direction and may at least partially overlap the front seal 644. Furthermore, the front bearing 650 may be at least partially aligned with the sealing surface 640b of the gear alignment component and/or the front seal 644 in the axial direction.

The transfer case assembly 600 may further comprise a front static seal 646 arranged between the gear alignment component 640 and the output flange component 630 for preventing, restricting or reducing leakage of lubricating fluids between the gear alignment component and the output flange component, e.g. out of the interior space 604.

As illustrated in FIG. 6, when the transfer case assembly 600 is provided on the vehicle 10, the transmission 20 assembly may be provided with a transmission seal 648 configured to prevent, restrict or reduce leakage of lubricating fluids out of the interior of the transmission assembly 20. The transmission seal 648 may be a dynamic seal arranged between the housing of the transmission assembly and the output shaft 26 of the transmission assembly.

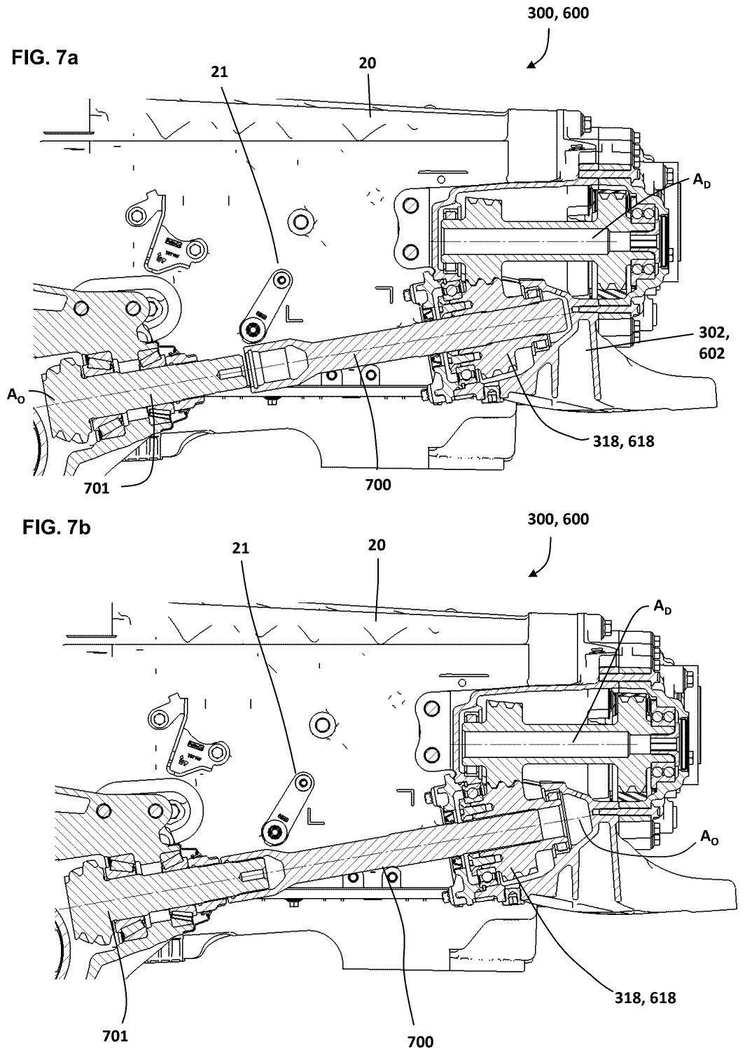

With reference to FIGS. 7a and 7b, the transfer case assembly 300, 600 may further comprise a transfer shaft 700 for coupling the output gear 318, 618 of the transfer case assembly to the pinion gear 51 of the front differential assembly, e.g. via a pinion shaft 701. As mentioned above, the output gear 318, 618 may be a conical gear and the axis of rotation A_{O} of the output gear may be at an angle relative to the axis of rotation A_{D} of the driven gear 316, 616. In particular, the axis of rotation A_{O} of the output gear may be aligned with the axis of rotation of the pinion gear 51. Accordingly, the transfer shaft 700 may be coupled to the input gear and the pinion 51 without an intervening universal joint, such as a continuous velocity joint. The transfer shaft 700 may therefore comprise a quill shaft, which may provide a suitable clearance between the transfer shaft 700 and a gear selector 21 of the transmission assembly.

As illustrated in FIG. 7a, the housing 302, 602 of the transfer casing assembly may be configured to receive a greater length of the transfer shaft 700 than during normal operation of the transfer case assembly in order to facilitate assembly of the transfer case assembly 300, 600 and front differential 60, e.g. coupling of the output gear 318, 618 of the transfer case assembly to the pinion gear 51 or pinion shaft 701 of the front differential by the transfer shaft 700.

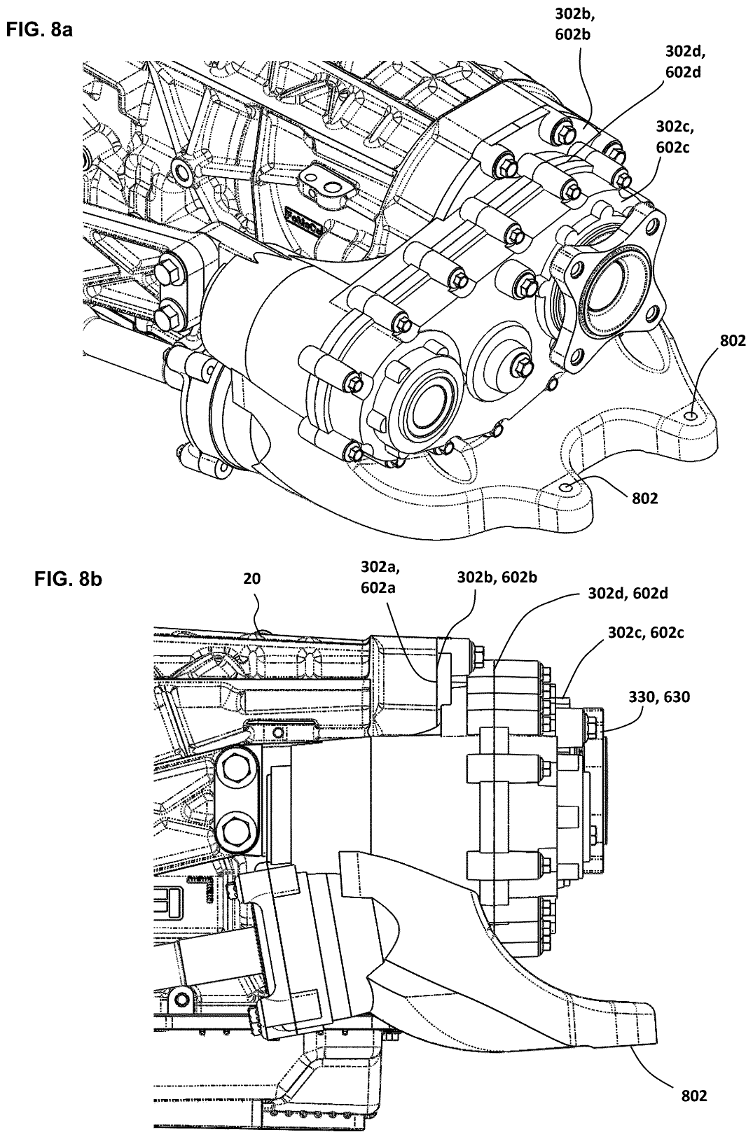

Referring to FIGS. 4 to 6, in addition to FIGS. 8a and 8b, the housing 302, 602 may comprise first and second housing components 302b, 302c, 602b, 602c, which may be coupled together at a split 302d, 602d in the housing in a plane perpendicular to an axial direction of the transfer case assembly. The split 302d, 602d may be aligned, e.g. axially aligned, with the input gear 312, 612 in particular, the split may be aligned with the meshing portion 312a, 612a of the input gear. The split may be between, e.g. axially between, the front bearing 650 and the rear bearing 328, 628.

As illustrated in FIGS. 8a and 8b, the housing 302, 602 of the transfer case assembly may comprise one or more mounting points 802 for mounting the transfer case assembly on the vehicle, e.g. to a frame of the vehicle. As illustrated, the mounting points 802 may be positioned rearwards of the transmission assembly and may be positioned on an opposite side of the output flange component 330, 630 from the transmission assembly 20.

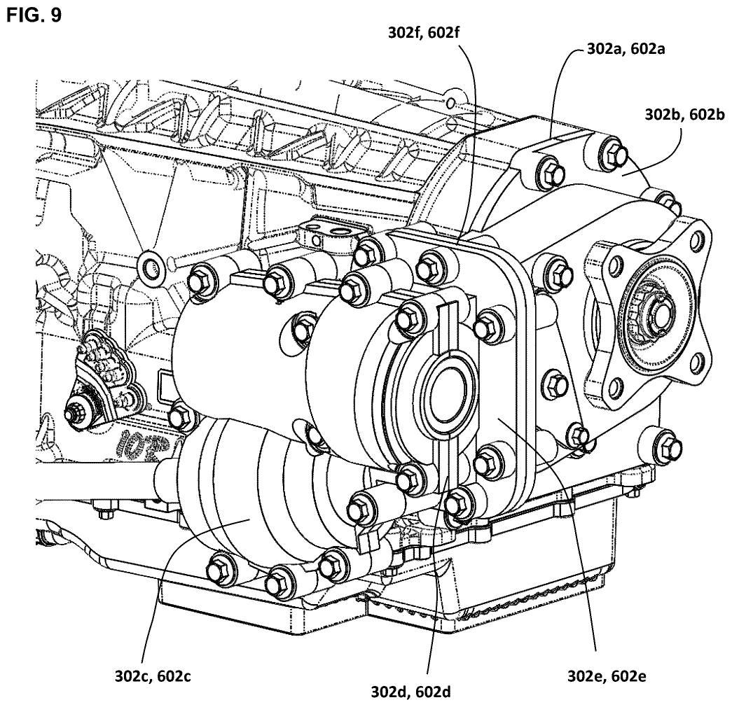

With reference to FIG. 9, in alternative arrangements of the transfer case assembly 300 or the transfer case assembly 600, the housing of the transfer case assembly may alternatively be split in a lateral direction of the transfer case assembly. As illustrated, the housing may comprise first and second housing parts and may comprise a split 302d, 3602d in the housing, which is in a plane perpendicular to the coupling surface 302a, 602b. The split may be aligned with a rotational axis of the output gear, e.g. in a lateral direction of the transfer case assembly.

The housing may further comprise a third housing part 302e, 602e coupled to, e.g. between, the first or second housing parts. The housing may comprise a further split 302f, 602f, which may be in a plane perpendicular to the coupling surface and may be between, e.g. laterally between, the rotational axis A_{I} of the input gear and the rotational axis A_{O} of the output gear.

As illustrated, the second and third housing parts may be coupled together at the split in the housing and the first and third housing parts may be coupled together at the further split in the housing.

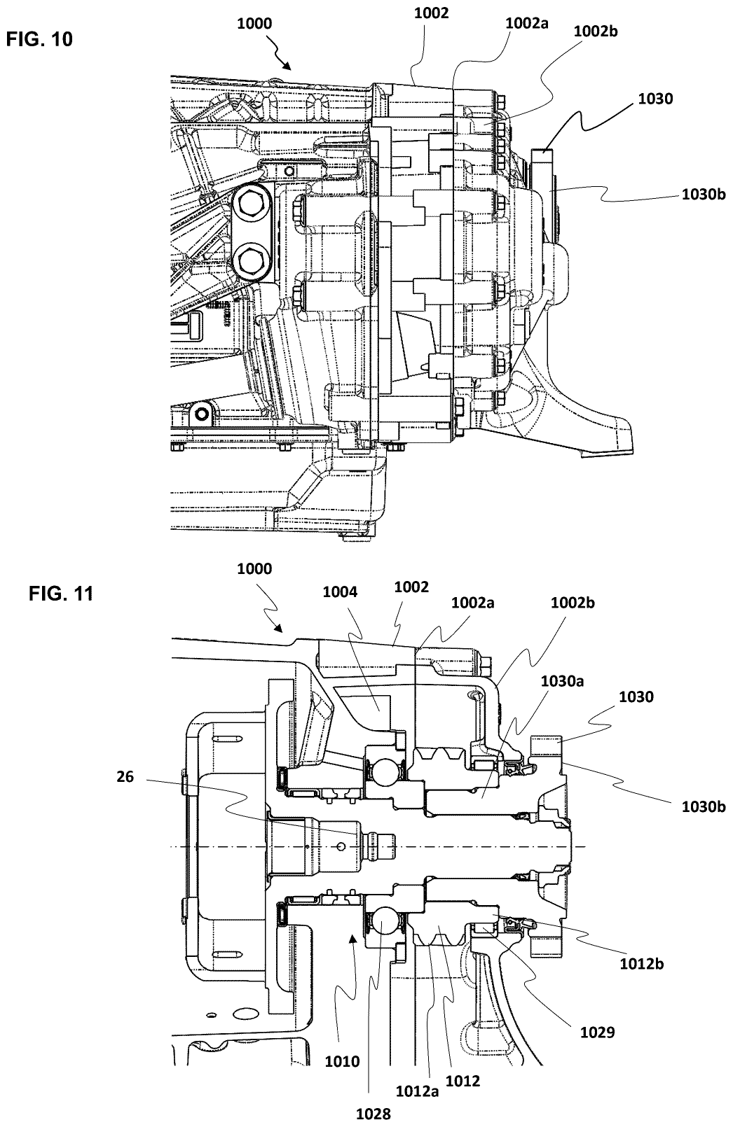

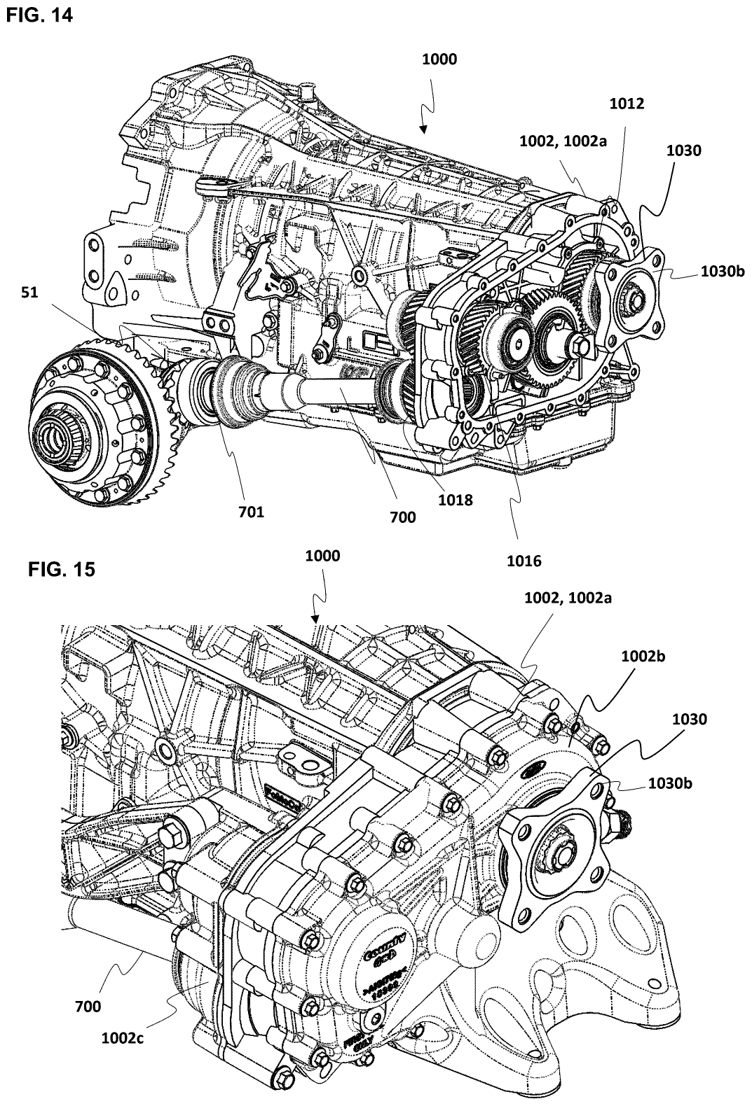

With reference to FIGS. 10 to 15, a transfer case assembly 1000 according to another arrangement of the present disclosure will now be described. The transfer case assembly 1000 may be similar to the transfer case assemblies 300, 600 described above and features described in relation to the transfer assemblies 300, 600 may apply equally to the transfer case assembly 1000, and vice versa.

The transfer case assembly 1000 differs from the transfer case assemblies 300, 600, in that the transfer housing 1002 of the transfer case assembly, e.g. the first housing part 302a, 602a, is integrally formed with the housing of the transmission assembly. In other words, a first part of the housing 1002 may be an integrated housing of the transmission assembly and the transfer case assembly, e.g. configured to at least partially house the transmission main shaft 22 (described above with reference to FIG. 1), the output shaft 26, in addition to one or more of the components of the transfer case assembly, as described below.

Accordingly, features of the transmission housing 24 and the housing 302, 602, e.g. the first part 302b, 602b of the housing, described above, may also apply to the integrated housing 1002. The transfer case assembly 1000 may similarly be provided within the vehicle 10, e.g. in place of the transfer assembly 30 and the housing 24, rather than the transfer case assembly 300, 600. The integrated housing 1002, e.g. a coupling surface of the integrated housing, may be configured to couple to the engine. An output flange component 1030 of the transfer case assembly 100, having a shaft portion 1030a and a flange portion 1030b, for coupling to the rear drive shaft 13, may be coupled to part of the output shaft 26, which may extend up to or beyond an opposite end 1002a of the integrated housing 1002 from the engine.

As illustrated in FIGS. 10, 11 and 12, the integrated casing 1002 forms an interior space 1004 for containing a drive mechanism 1010 of the transfer case assembly. The transfer case assembly 1000 may further comprise a second housing part 1002b, which is similar to the second housing parts 302c, 602c, described above. The second housing part 1002b may be coupled to the integrated casing, e.g. at a flange formed at the opposite end 1002a of the integrated housing from the engine. The interior space 1004 may be at least partially formed by the second housing part 1002b. The output shaft 26 may extend through the integrated casing 1002, e.g. up to or beyond the opposite end 1002a of the integrated housing 1002 from the engine, and may extend through the second housing part 1002b. The flange portion 1030a of the output flange component 1030 may be disposed outside the interior space 1004 for coupling to the rear drive shaft 13.

In the arrangement illustrated, the drive mechanism 1010 comprises a gear drive, which is similar to the gear drive of the drive mechanisms 310, 610 describe above. In particular, the drive mechanism 1010 may comprise an input gear 1012, a driven gear 1016 and a conical driven gear 1022, mounted on a driven shaft 1020, and an output gear 1018, which may be arranged within the drive mechanism 1010 similarly to how the input gear 312, 612, driven gear 318, 618, conical driven gear 322, 622, driven shaft 320, 620 and output gear 318, 618 of the drive mechanisms 310, 610 are arranged within the drive mechanisms 310, 610, as described above. In other arrangements, the drive mechanism may comprise a belt or chain drive, as described above with reference to FIG. 3b.

The drive mechanism 1010 differs from the drive mechanisms 310, 610 in that bearings for supporting the rotation of the output shaft 26 and/or driven shaft 1020 may be mounted on the integrated housing 1002. In particular, a bearing 1028 for supporting, e.g. radially and/or axially supporting, rotation of the output shaft 26 and output flange component 1030 may be mounted in the integrating housing.

As illustrated in FIG. 11, the bearing 1028 may be provided on an opposite side of the input gear 1012 from the output flange component, e.g. the flange part 1030b of the output flange component. This may be in contrast to the bearing 328, 628 being supported on the second housing part 302b, 602b, and being arranged between, e.g. axially between, the input gear 312, 612 and the flange portion 330b of the output flange component.

Further, as illustrated in FIG. 11, the bearing 1028 may be mounted on the output shaft 26 in contrast to being mounted on, e.g. directly on, the output flange component in the arrangements shown in FIGS. 4 and 6. However, in other arrangements, the bearing 1028 may be mounted on the output flange component 1030, e.g. on the shaft portion 030a.

In some arrangements, the transfer case assembly 1000 may comprise a further bearing 1029 for supporting, e.g. radially and/or axially supporting, rotation of the output shaft and/or output flange component 1030. The further bearing may be mounted in the second housing part 1002b. The further bearing may be mounted on, e.g. directly on, the input gear 1012, as shown in FIG. 11, or on the output flange component or output shaft. The further bearing 1029 may be arranged axially between the input gear, e.g. a meshing portion 1012a of the input gear and the flange portion of the output flange component. As shown, the input gear may comprise an extension portion 1012b extending axially relative to the meshing portion, e.g. towards the output flange component. The further bearing may be mounted, e.g. directly mounted, on the extension portion 1012b.

In the arrangements illustrated, the bearing 1028 is configured to support the output shaft, input gear, and/or output flange component in axial and radial directions of the output shaft, and the further bearing 1029 is configured to support the output shaft 26, input gear, and/or output flange component in the radial direction only. For example, the bearing 1028 may be a ball bearing, and the further bearing 1029 may be a roller bearing. However, in other arrangements, the bearing and further bearing may comprise any other desirable form of bearing.

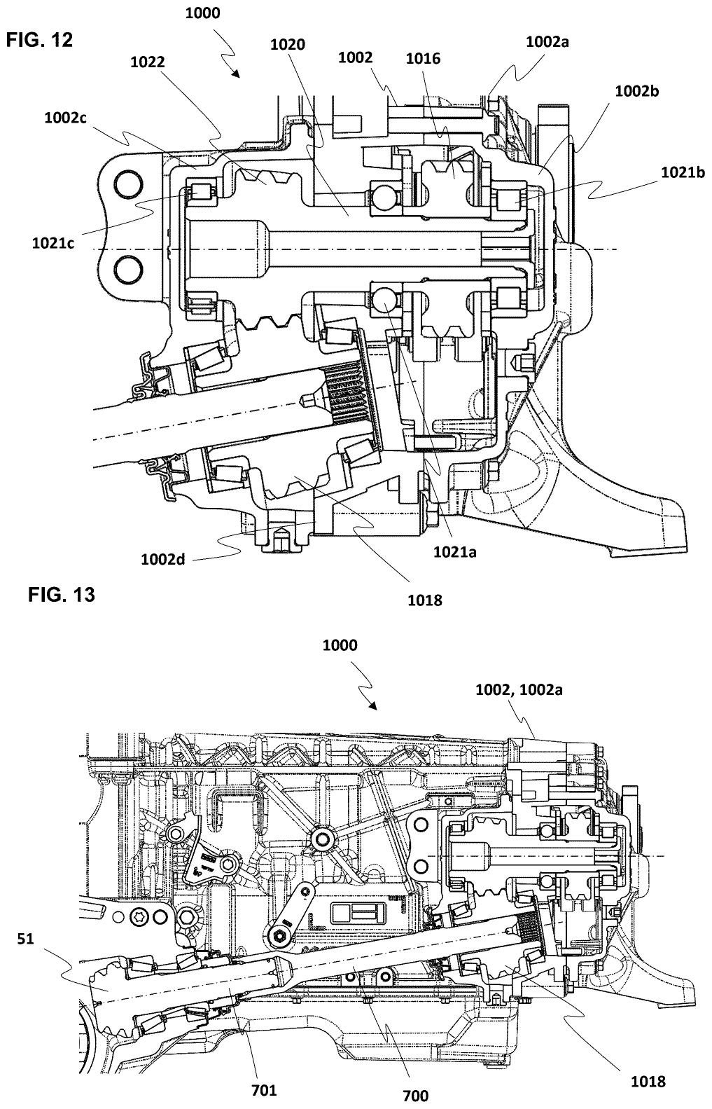

As shown in FIGS. 12 and 15, the transfer case assembly 1000 may further comprise a third housing part 1002c, which may be coupled to the integrated housing at a split line 1002d perpendicular to the axial direction of the output shaft and the driven shaft and arranged between, e.g. axial between, the driven gear 1016, and the conical driven gear 1022 and/or output gear 1018. As illustrated in FIG. 12, the output gear and/or the conical driven gear 1022, may be received, e.g. substantially completely received within the third housing part 1002c.

As further illustrated in FIGS. 12 and 13, a first driven shaft bearing 1021a, for supporting, e.g. radially and/or axially supporting, rotation of the driven shaft 1020 may be mounted on the integrated housing 1002. Second and/or third driven shaft bearings 1021b, 1021c for supporting, e.g. radially and/or axially supporting, rotation of the driven shaft may be mounted on the second and third parts 1002b, 1002c of the transfer case housing respectively. The first driven shaft bearing may therefore be arranged between, e.g. axially between the second and third driven shaft bearings. In the arrangement depicted, the first driven shaft bearing 1021a is configured to support the rotation of the driven shaft in radial and axial directions, and the second and third bearings are configured to support rotation of the driven shaft in radial directions only. For example, the first driven shaft bearing may comprise a ball bearing and the second and third driven shaft bearings may comprise roller bearings. However, in other arrangements one, more than one or each of the first, second and third driven shaft bearings may be different forms of bearings, as desired.

The manner in which the driven shaft 1020 is supported within the integrated housing, may be in contrast to the driven shaft 320, 620 within the transfer case assembly 300, 600, which may be supported, e.g. axially and radially supported, by a rear driven shaft bearing mounted on the second housing part 302b, 602b, and supported, e.g. in a radial direction only, by a front driven shaft bearing being mounted on the first part 302a, 602a of the housing.

As illustrated in FIGS. 12 to 15, the output gear 1018 may be mounted and supported in the transfer case assembly, e.g. by the third part 1002c of the transfer housing, in the same way that the output gear 318, 618 is supported within the transfer case assembly 300, 600 described above. However, it will be appreciated that the form of bearing used to axially and radially support the rotation of the output gear may differ between the arrangements and/or may be interchangeable between the arrangements described. In particular, as shown in FIG. 12 the output gear 1018 may be supported within the transfer case assembly by a pair of tapered roller bearings provided on either side of the output gear (in the axial direction). In contrast, in the arrangement shown in FIG. 5, the output gear 318 is supported by a roller bearing and a ball bearing provided on opposite sides of the output gear (in the axial direction) respectively.

As further illustrated in FIGS. 12 to 15, the transfer case assembly 1000 may further comprise the transfer shaft 700 for coupling the output gear 1018 of the transfer case assembly to the pinion gear 51 of the front differential assembly, e.g. via a pinion shaft 701, as described above.

The following additional statements of invention also form part of the present specification:
Statement 1. A transfer case assembly for transferring torque from a transmission assembly of a motor vehicle to first and second sets of driven wheels of the motor vehicle, the transfer case assembly comprising:
   a housing having a coupling surface for coupling to a housing of the transmission assembly;
   an input gear for coupling to an output shaft of the transmission assembly;
   an output flange component for coupling to the output shaft of the transmission assembly, wherein the output flange is for coupling to the first set of driven wheels of the vehicle and
   an output gear drivingly connected to the input gear, wherein the output gear is for coupling to the second set of driven wheels of the vehicle and wherein the output gear is arranged on an opposite side of the coupling surface from the input gear.
Statement 2. The transfer case assembly of statement 1, wherein the output flange is configured to be coupled, e.g. directly coupled, to a first drive shaft for driving the first set of driven wheels, in order to transmit torque directly from the output shaft to the first drive shaft.
Statement 3. The transfer case assembly of statement 2, wherein the input gear is arranged for rotation together with the output flange component.
Statement 4. The transfer case assembly of any of the preceding statements, wherein the assembly further comprises a bearing configured to support rotation of the output flange component.
Statement 5. The transfer case assembly of any of statements 1 to 3, wherein the input gear and/or a bearing configured to support rotation of the output flange component is directly mounted on the output flange component.
Statement 6. The transfer case assembly of any of the preceding statements, wherein the housing is configured to couple to the housing of the transmission assembly such that an interior space of the transfer case assembly is in fluidic communication with an interior of the housing of the transmission assembly.
Statement 7. The transfer case assembly of statement 6, wherein the transfer case assembly is free from seals, e.g. dynamic seals, for sealing between an opening at the coupling surface between an interior of the transmission assembly casing and an interior of the transfer case assembly housing, and the input gear.
Statement 8. The transfer case assembly of any of the preceding statements, wherein the assembly further comprises:
   a gear alignment component configured to couple to the output flange component and axially locate the input gear relative to the output flange component.
Statement 9. The transfer case assembly of statement 8, wherein the gear alignment component is configured to couple to the output flange component using a threaded coupling.
Statement 10. The transfer case assembly of statement 8 or 9, wherein the gear alignment component comprises a seal surface arranged between the coupling surface and the interior space of the transfer case assembly.
Statement 11. The transfer case assembly of any of statements 1 to 6 or 8 to 10, wherein the transfer case assembly further comprises a seal, e.g. a dynamic seal and/or a static seal, configured prevent or restrict lubricating oil from passing between the coupling surface of the transfer case housing and an interior space of the transfer case housing.
Statement 12. The transfer case assembly of statements 10 and 11, wherein the seal is configured to engage the seal surface of the gear alignment component in order to prevent or restrict lubricating oil from passing between the coupling surface of the transfer case housing and the interior space of the transfer case housing.
Statement 13. The transfer case assembly of statement 11 or 12, wherein the input gear further comprises an extension portion protruding axially from a meshing portion of the input gear towards the coupling surface, wherein the extension portion at least partially overlaps the seal in the axial direction of the shaft.
Statement 14. The transfer case assembly of statement 13, when depending on statement 4, wherein the bearing is arranged between, e.g. radially between, the extension portion and the housing.
Statement 15. The transfer case assembly of statement 4 or any of statements 5 to 14 when depending on statement 4, wherein the assembly comprises a further bearing for supporting rotation of the input gear, wherein the further bearing is arranged on an opposite side of the input gear, e.g. the meshing portion, from the bearing.
Statement 16. The transfer case assembly of any of the preceding statements, wherein a dimension of the transfer case assembly between the coupling surface and a flange surface of the output flange component is less than approximately 250 mm.
Statement 17. The transfer case assembly of any of the preceding statements, wherein a rotational axis of the output gear is at an angle relative to a rotational axis of the input gear.
Statement 18. The transfer case assembly of any of the preceding statements, wherein the transfer case assembly further comprises a conical driven gear drivingly connected to the input gear, wherein the conical driven gear is meshingly coupled with the output gear.
Statement 19. The transfer case assembly of any of the preceding statements, wherein the housing comprises first and second housing parts coupled together at a split in the housing, wherein the split is in a plane perpendicular to the input axis at a position aligned with the input gear.
Statement 20. The transfer case assembly of statement 15 or any of statements 16 to 19 when depending on statement 15, wherein the housing comprises first and second housing parts coupled together at a split in the housing, wherein the split is in a plane perpendicular to the input axis at a position between the bearing and the further bearing.
Statement 21. The transfer case assembly of any of the preceding statements, wherein the housing comprises first and second housing parts and a split in the housing between the first and second housing parts, wherein the split is in a plane perpendicular to the coupling surface and is aligned with a rotational axis of the output gear.
Statement 22. The transfer case assembly of any of the preceding statements, wherein the housing comprises a third housing part coupled to, e.g. between, the first or second housing part and a further split in the housing between the first and second housing parts, wherein the further split is in a plane perpendicular to the coupling surface and between the rotational axis of the input gear and the rotational axis of the output gear.
Statement 23. a Motor Vehicle Comprising:
   the transfer case assembly of any of the preceding statements.
Statement 24. The motor vehicle of statement 23 further comprising the transmission assembly or the housing of the transmission assembly.
Statement 25. The motor vehicle of statement 23 or 24 further comprising a differential assembly having an input gear, wherein a rotational axis of the input gear is aligned with a rotational axis of the output gear of the transfer case assembly.

It will be appreciated by those skilled in the art that although the invention has been described by way of example, with reference to one or more exemplary examples, it is not limited to the disclosed examples and that alternative examples could be constructed without departing from the scope of the invention as defined by the appended claims.

1. A transfer case assembly for transferring torque from a transmission assembly of a motor vehicle to first and second sets of driven wheels of the motor vehicle, the transfer case assembly comprising:
a housing, including an integrated transmission and transfer case housing part, the integrated housing part configured to at least partially house a transmission main shaft and a transmission output shaft of the transmission assembly;
an input gear for coupling to transmission output shaft;
an output flange component for coupling to the output shaft of the transmission assembly, wherein the output flange component is for coupling to the first set of driven wheels of the vehicle; and
an output gear drivingly connected to the input gear, wherein the output gear is for coupling to the second set of driven wheels of the vehicle.

2. The transfer case assembly of claim 1, wherein the integrated transmission and transfer case housing part comprises a coupling surface for coupling to an engine of a vehicle.

3. The transfer case assembly of claim 1, wherein the output flange is configured to be coupled to a first drive shaft for driving the first set of driven wheels, in order to transmit torque directly from the output shaft to the first drive shaft.

4. The transfer case assembly of claim 1, wherein the input gear is arranged for rotation together with the output flange component.

5. The transfer case assembly of claim 1, wherein the assembly further comprises a bearing configured to support rotation of the output flange component.

6. The transfer case assembly of claim 5, wherein the bearing configured to support rotation of the output flange component is directly mounted in the integrated transmission and transfer case housing part.

7. The transfer case assembly of claim 5, wherein the bearing configured to support rotation of the output flange component is directly mounted on the transmission output shaft.

8. The transfer case assembly of claim 5, wherein the assembly further comprise a further bearing for supporting rotation of the output flange component, wherein the further bearing is arranged on an opposite side of the input gear from the bearing.

9. The transfer case assembly of claim 8, wherein the input gear further comprises an extension portion protruding axially from a meshing portion of the input gear, wherein the further bearing is arranged between the extension portion and the housing.

10. The transfer case assembly of claim 1, wherein a rotational axis of the output gear is at an angle relative to a rotational axis of the input gear.

11. The transfer case assembly of claim 1, wherein the transfer case assembly further comprises a conical driven gear drivingly connected to the input gear, wherein the conical driven gear is meshingly coupled with the output gear.

12. The transfer case assembly of claim 1, wherein the transfer case assembly further comprises a driven shaft bearing for supporting rotation of a driven shaft drivingly coupled to the input gear and the output gear, wherein the driven shaft bearing is directly mounted in the integrated transmission and transfer case housing part.

13. The transfer case assembly claim 1, wherein the housing comprises the integrated transmission and transfer case housing part and a second housing part coupled together at a split in the housing, wherein the split is in a plane perpendicular to the input axis at a position aligned with the input gear.

14. The transfer case assembly of claim 8, wherein the housing comprises the integrated transmission and transfer case housing part and a second housing part coupled together at a split in the housing, wherein the split is in a plane perpendicular to the input axis at a position between the bearing and the further bearing.

15. The transfer case assembly of claim 14, wherein the further bearing is mounted in a second housing part of the housing.

16. A transfer case assembly for transferring torque from a transmission assembly of a motor vehicle to first and second sets of driven wheels of the motor vehicle, the transfer drive assembly comprising:
an output flange component configured to be coupled to an output shaft of the transmission assembly and coupled to a first drive shaft for driving the first set of driven wheels, in order to transmit torque directly from the output shaft to the first drive shaft;
an input gear arranged for rotation together with the output flange component; and
a bearing configured to support rotation of the input gear, wherein the input gear and/or bearing is directly mounted on the output flange component.

17. A motor vehicle comprising:
the transfer case assembly of claim 1.

18. The motor vehicle of claim 17 further comprising the transmission assembly.

19. The motor vehicle of claim 17 further comprising a differential assembly having an input gear, wherein a rotational axis of the input gear is aligned with a rotational axis of the output gear of the transfer case assembly.
